(19) United States
(12) Patent Application Publication
(10) Pub. No.: US 2009/0065997 A1
(43) Pub. Date: Mar. 12, 2009

(54) Image forming apparatus

(75) Inventor: Hiroshi Yamaguchi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 12/012,750

(22) Filed: Feb. 5, 2008

(30) Foreign Application Priority Data
Sep. 12, 2007 (JP) 2007-236686

(51) Int. Cl. B41F 13/00; B65H 83/00

(52) U.S. Cl. 270/1.01; 271/3.09

(57) ABSTRACT

Disclosed is an image forming apparatus comprising: a feeding section to perform a feeding of printing sheets; an image forming section to perform an image forming for the printing sheets fed by the feeding section; an ejection tray to which the printing sheets for which the image forming is performed by the image forming section are ejected; an input section to receive a pause condition of the feeding performed by the feeding section; and a control section to instruct the feeding section to pause the feeding based on the pause condition received by the input section.

### BACKGROUND OF THE INVENTION

1. Field of the Invention

The present invention relates to an image forming apparatus.

2. Description of Related Art

In recent years, there is an image forming apparatus in which images are formed on printing sheets, and the number of printing sheets or copies of the printing sheets to be output specified by a print job are ejected to a specified ejection tray, based on the print job. Especially in a Print On Demand (POD)-system image forming apparatus, the image forming apparatus can comprise a plurality of stackers having an ejection tray on which a mass of printing sheets can be loaded. Such apparatus comprises a function (a stacker auto-switching function) in which even when one stacker reaches the limit of the loading capacity, it is switched to another stacker to load the printing sheets, and thus the performing of the print job is continued.

When the stacker auto-switching function is active, there is a case where the printing sheets on which an image is formed based on one print job are ejected in a state of being divided into a plurality of stackers. In such a case, there was a possibility that the connection between groups of the printing sheets loaded on each of the stackers could not be determined. That is, the groups of the printing sheets divided into each of the stackers essentially belong to one print job. However, for example, there was a case in which it was difficult to determine which of the stacker on which the last printing sheet of the group of the printing sheets is loaded is followed by a primary printing sheet of the group of the printing sheets loaded on one stacker. This becomes a factor of reducing the efficiency of the sorting task of print jobs.

According to Japanese Patent Application Laid Open Publication No. 2000-318913, a technique is disclosed in which a state where the stacker is reaching its capacity limit is detected in advance, and the number of printing sheets of a print job and the number of remaining printing sheets until the stacker reaches its capacity limit, are compared. Thus, an apparatus is controlled so as to switch to another available stacker before the active stacker reaches its capacity limit.

The conventional technique can prevent the ejected printing sheets from being divided into and loaded on a plurality of stackers in one print job. However, when the print job comprises a plurality of copies composed of a mass number of printing sheets, one copy may be divided into and loaded on a plurality of stackers. Accordingly, a sorting task per each copy occurs, and it is troublesome for users.

### SUMMARY OF THE INVENTION

The image forming apparatus reflecting one aspect of the present invention comprises:

a feeding section to perform a feeding of printing sheets;

an image forming section to perform an image forming for the printing sheets fed by the feeding section;

an ejection tray to which the printing sheets for which the image forming is performed by the image forming section are ejected;

an input section to receive a pause condition of the feeding performed by the feeding section; and

a control section to instruct the feeding section to pause the feeding based on the pause condition received by the input section.

### BRIEF DESCRIPTION OF THE DRAWINGS

The present invention will become more fully understood from the detailed description given hereinbelow and the appended drawings which are given by way of illustration only, and thus are not intended as a definition of the limits of the present invention, and wherein:

FIG. 1 is a schematic sectional configuration diagram of an image forming apparatus in an embodiment 1;

FIG. 2 is a control block diagram of the image forming apparatus;

FIG. 3 is a flow chart of feeding-pause processing in the embodiment 1;

FIG. 4 is the flow chart of feeding-pause processing in the embodiment 1 (continued from FIG. 3);

FIG. 5 is a flow chart of a substitution example of steps S9 and S18 when a state of an ejection tray T3 is set as a restarting condition;

FIG. 6 is a schematic configuration diagram of the image forming apparatus;

FIG. 7 is a schematic configuration diagram of an image forming apparatus in an embodiment 2;

FIG. 8 is a flow chart of feeding-pause processing in the embodiment 2; and

FIG. 9 is the flow chart of feeding-pause processing in the embodiment 2 (continued from FIG. 8).

### DESCRIPTION OF THE PREFERRED EMBODIMENTS

### Embodiment 1

Hereinbelow, an embodiment 1 of the present invention will be described in detail with reference to the drawings.

First, the configuration is described.

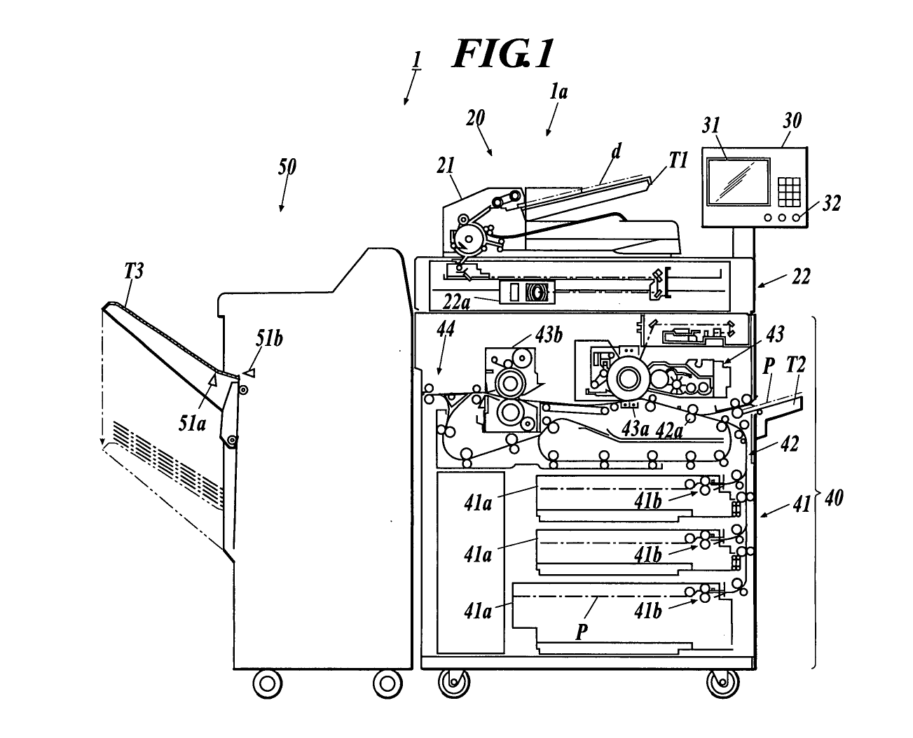

FIG. 1 is a schematic sectional configuration diagram of an image forming apparatus 1 in the embodiment 1.

As shown in FIG. 1, the image forming apparatus 1 is a digital multi-function peripheral comprising a main body part 1a; and a post-processing part 50 to perform a post-processing to printing sheets on which images are formed, and the like. In the main body part 1a, images are read from a document so that the read images are formed on a printing sheet P. Further, in the main body part 1a, a job including a page data having an image data and including an image forming condition and the like of each image data, is received from an external device and the like to form an image on the printing sheet P based on the received job. As shown in FIG. 1, the main body part la comprises an image reading section 20; an operation displaying section 30; a printing section 40 and the like.

The image reading section 20 comprises an auto document feeding unit 21 which is referred to as an Auto Document Feeder (ADF); and a reading unit 22. A document d loaded on a document tray T1 of the auto document feeding unit 21 is fed to a contact glass at which the reading is performed. Images on one side or both sides of the document d are read by an optical system, and the images on the document d are read by a Charge Coupled Device (CCD) 22a. Here, the images are not limited to an image data such as a graphic, a photograph and the like, but include a text data and the like such as a character, a symbol and the like.

The images (analog image signal) read by the image reading section 20, are output to a later described reading processing unit 140 of an image control substrate. After an analog-digital (A/D) conversion and various image processing are carried out for the images in the reading processing unit 140, the images are output to the printing section 40.

The operation displaying section 30 comprises a Liquid Crystal Display (LCD); a touch panel 31 provided so as to cover the LCD; a restarting button 32 to receive an instruction for restarting the feeding of the sheets by the feeding unit 41; and other operation key groups (not shown). The operation displaying section 30 receives an input of a user to output the input information to a control unit 110, and displays various setting screens to input various setting conditions, various processing results and the like, according to a display signal input from the control unit 110.

On the touch panel 31 of the operation displaying section 30, when a job is performed, a screen is displayed so as to receive an instruction of whether a later described feeding-pause processing is performed or not, and to receive a feeding-pause condition of printing sheets by the feeding unit 41 when the feeding-pause processing is performed. An operation signal indicating the instruction and the feeding-pause condition received by the screen is output to the control unit 110. Accordingly, the operation displaying section 30 comprising the touch panel 31 and the restarting button 32 functions as an input section.

The pause condition in the present embodiment 1 is the number of printing sheets fed by the feeding unit 41, or the number of copies ejected to a later described ejection tray. The operation displaying section 30 receives either the number of printing sheets or the number of copies as the pause condition.

The printing section 40 performs an image forming processing of an electrophotographic system based on the input print data. The printing section 40 comprises the feeding unit 41; a feeding conveying unit 42; an image forming unit 43; and a discharging unit 44.

The feeding unit 41 comprises a plurality of feeding trays 41a; feeding instruments 41b; a manual tray T2 and the like. The printing sheets P, each of the types of which is identified in advance, are accommodated in each of the feeding trays 41a. The feeding tray 41a conveys the printing sheets P per one printing sheet from the top toward the feeding conveying unit 42. The manual tray T2 can load various types of the printing sheet P in accordance with a need of a user, and conveys the loaded printing sheets P per one printing sheet from the top toward the feeding conveying unit 42 by a feeding roller.

The feeding conveying unit 42 conveys the printing sheets P conveyed from the feeding tray 41a or the manual tray T2 to a transcription equipment 43a through a plurality of intermediate rollers and a resist roller 42a.

Further, the feeding conveying unit 42 conveys the printing sheets P, one side of which having already been performed with an image forming, to both sides-conveying path by a conveying path switching board, and conveys thereof again to the transcription equipment 43a through the intermediate rollers and the resist roller 42a.

The image forming unit 43 comprises a photoconductor drum; a charging equipment; an exposure equipment having a laser outputting portion to output laser beam based on an image data, and a polygon mirror to scan the laser beam in a main scanning direction; a development equipment; the transcription equipment 43a; a cleaner; and a fusing equipment. Concretely, the photoconductor drum charged by the charging equipment is irradiated with the laser beam by the exposure equipment, and an electrostatic latent image is formed. Then, a charged toner is attached to a surface of the photoconductor drum on which the electrostatic latent image is formed to develop the electrostatic latent image by the development equipment. The toner image formed on the photoconductor drum by the development equipment is transferred to the printing sheets P at the transcription equipment 43a. Further, after the toner image is transferred to the printing sheets P, a remaining toner and the like on the surface of the photoconductor drum is removed by the cleaner.

The fusing equipment 43b heat-fuses the toner image transferred to the printing sheets P conveyed by the feeding conveying unit 42. The printing sheets P performed with the fusing processing are conveyed to the post-processing part 50 from a discharging port in a state of being sandwiched by an ejecting roller of the discharging unit 44.

The post-processing part 50 comprises a post-processing section such as a sorting unit to perform a sorting processing for printing sheets on which an image is formed, a punching unit to perform a punching processing, a stapling unit to perform a stapling processing in which a stack of printing sheets are bound at a set binding position, a folding unit to perform a folding processing, a cutting unit to perform a cutting processing and the like; and an ejection tray T3 at which printing sheets on which an image is formed by the main body part la and printing sheets on which various post-processing has been performed, are ejected and loaded.

The ejection tray T3 comprises a printing sheet sensor 51a; and a position sensor 51b, as a detecting section to detect the state of the ejection tray T3. The printing sheet sensor 51a is a sensor to detect whether there is a printing sheet on the ejection tray T3 or not, realized by using an optical or mechanical sensor. The position sensor 51b is comprised when the ejection tray T3 moves up and down, to detect the position (initial position) of the ejection tray in a state where there is no printing sheet on the ejection tray T3, realized by using an optical or mechanical sensor.

That is, the state of the ejection tray T3 is a state indicating whether there is printing sheet on the ejection tray T3 or not, and whether the position of the ejection tray T3 is at the initial position or not.

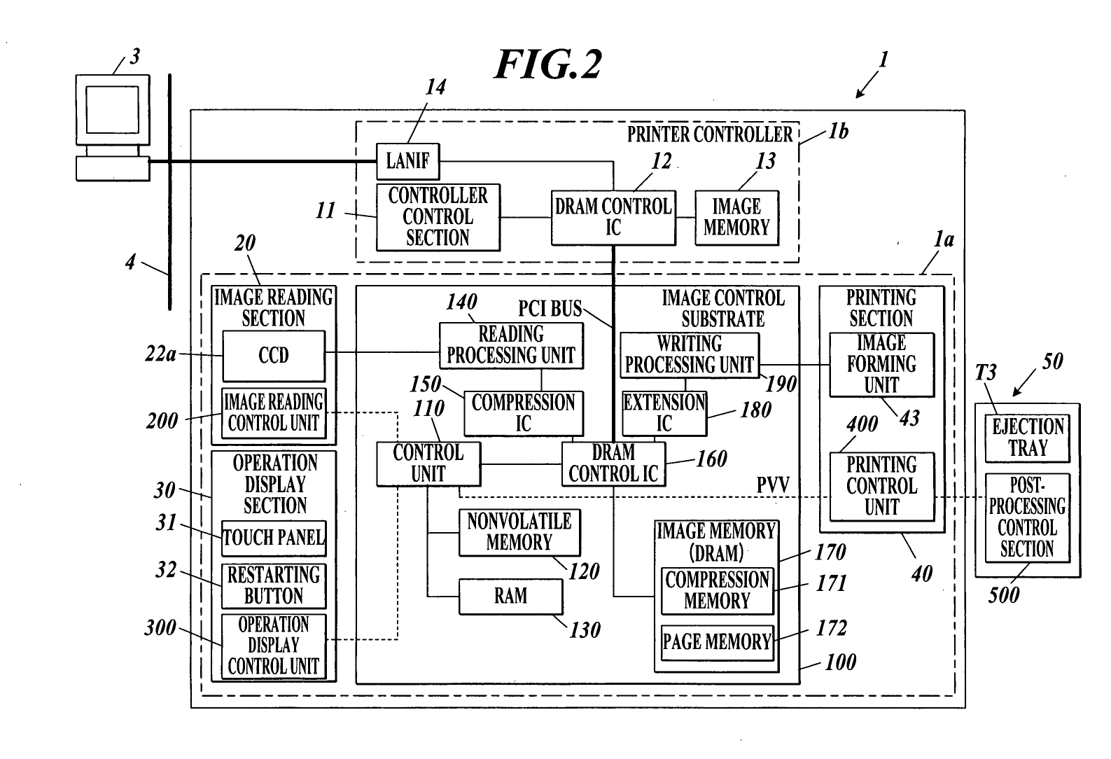

FIG. 2 is a control block diagram of the image forming apparatus 1.

As shown in FIG. 2, the image forming apparatus 1 comprises the main body part 1a; a printer controller 1b; and the post-processing part 50 which is connected to the main body part 1a. The image forming apparatus 1 is connected to an external device 3 on a network 4 so as to be able to mutually send and receive information through Local Area Network Interface (LANIF) 14 of the printer controller 1b.

The main body part 1a comprises the image reading section 20; the operation displaying section 30; the printing section 40; and an image control substrate 100. Incidentally, a configuration which is the same as that of each unit described in FIG. 1 is given the same symbol to omit the description thereof.

The image control substrate 100 comprises the control unit 110; a nonvolatile memory 120; a Random Access Memory (RAM) 130; the reading processing unit 140; a compression IC 150; a Dynamic Random Access Memory (DRAM) control IC 160; an image memory 170; an extension IC 180; and a writing processing unit 190.

The control unit 110 comprises a Central Processing Unit (CPU) and the like, and retrieves a program specified from system programs and various application programs stored in the nonvolatile memory 120 to expand the specified program in the RAM 130. The control unit 110 executes various processing in cooperation with the program expanded in the RAM 130 to integrally control each unit of the image forming apparatus 1.

For example, the control unit 110 performs the control of switching a copy mode; printer mode; and scanner mode, copying, printing, and reading an image data and the like, according to the instruction signal input from the operation displaying section 30 and the external device 3.

The control unit 110 controls the following processing. That is, the control unit 110 retrieves a feeding-pause processing program at the time of executing the job according to the present embodiment 1, an instruction of whether to execute the feeding-pause processing or not, and various data such as the pause condition and the like from the nonvolatile memory 120, to make the feeding by the feeding unit 41 to pause based on the pause condition, in cooperation with the program and various data. After the feeding by the feeding unit 41 is made to pause based on the pause condition, the control unit 110 controls the processing of restarting the feeding by the feeding unit based on a restarting condition which is set in advance.

There are two cases as the restarting condition, which are whether the restarting button is pushed down or not, and a state of the ejection tray T3. Either one of the two cases is chosen as the restarting condition.

The nonvolatile memory 120 stores various processing programs and data regarding an image forming, the feeding-pause processing program of the present embodiment 1, the instruction data of whether to execute the feeding-pause processing or not, the pause condition, the restarting condition, data processed by various programs and the like.

The RAM 130 forms a work area to temporarily store various programs executed by the control unit 110, data regarding these programs, various data which configures a job and the like.

The reading processing unit 140 performs various processing such as an analog processing, A/D conversion processing, and a shading processing and the like, for an analog image signal input from an image reading control unit 200 of the image reading section 20, to generate a digital image data. The generated image data is output to the compression IC 150.

The compression IC 150 performs a compression processing for the input digital image data to output the compressed data to the DRAM control IC 160.

The DRAM control IC 160 controls the compression processing of an image data by the compression IC 150 and the extension processing of the compressed image data by the extension IC 180, according to the instruction from the control unit 110. Further, the DRAM control IC 160 controls an input and an output of an image data to the image memory 170. For example, when the image signal retrieved by the image reading section 20 is instructed to be stored, the DRAM control IC 160 instructs the compression IC 150 to execute the compression processing for the image data input from the reading processing unit 140, to store the compressed image data in a compression memory 171 of the image memory 170. Further, when the compressed image data stored in the compression memory 171 is instructed to be print output, the DRAM control IC 160 retrieves the compressed image data from the compression memory 171, instructs the extension IC 180 to perform the extension processing to store the extended data in the page memory 172. Moreover, when the image data stored in the page memory 172 is instructed to be print output, the DRAM control IC 160 retrieves the image data from the page memory 172 to output the image data to the writing processing unit 190.

The image memory 170 comprises the compression memory 171 composed of the Dynamic RAM (DRAM); and the page memory 172. The compression memory 171 is a memory to store a compressed image data. The page memory 172 is a memory to temporarily store an image data for print output (print data).

The extension IC 180 performs the extension processing to the compressed image data.

The writing processing unit 190 generates a print data for an image forming based on an image data input from the DRAM control IC 160, to output the print data to the printing section 40.

The image reading section 20 comprises a CCD 22a; image reading control unit 200; the auto document feeding unit 21; and the reading unit 22 and the like (not shown here but shown in FIG. 1). The image reading control unit 200 controls the auto document feeding unit 21 and the reading unit 22 and the like, to have an exposure scanning of a document surface executed. The image reading control unit 200 instructs the CCD 22a to perform a photoelectric conversion for a reflection of light to read an image. The read analog image signal is output to the reading processing unit 140.

The operation displaying section 30 comprises the touch panel 31; the restarting button 32; an operation display control unit 300; and operation key groups such as a numeric keypad and the like (not shown). The operation display control unit 300 displays various setting screens to input various setting conditions, and various processing results and the like on the LCD, according to a display signal input from the control unit 110. Further, the operation display control unit 300 outputs an operation signal input from the restarting button 32, the operation key groups or the touch panel 31, to the control unit 110.

The printing section 40 comprises each of the units regarding a print output such as the image forming unit 43 shown in FIG. 1; and a printing control unit 400. The printing control unit 400 controls operations of each unit of the printing section 40, such as the image forming unit 43 and the like, according to an instruction from the control unit 110, to have an image forming performed on the printing sheets P based on the print data input from the writing processing unit 190. Further, the printing control unit 400 outputs an instruction signal to operate each unit of the post-processing part 50 according to the instruction from the control unit 110, to a post-processing control section 500.

The post-processing part 50 comprises various post-processing units; a conveying equipment such as a conveying roller and the like to convey the printing sheets to the various post-processing units; and the ejection tray T3 to which the printing sheets conveyed from the various post-processing units are ejected, and the like. The various post-processing units are integrally controlled by the post-processing control section 500. The post-processing control section 500 performs the following control. That is, the post-processing control section 500 conveys the printing sheets P to a predetermined post-processing unit along the conveying path, according to an instruction signal of the post-processing input from the control unit 110 through the printing control unit 400. The post-processing control section 500 drive controls each unit to have the printing sheets P performed with the predetermined post-processing, to eject the printing sheets P to the ejection tray T3.

Next, each unit of the printer controller 1b is described in detail. The printer controller 1b administrates and controls a job input to the image forming apparatus 1 from the external device 3 connected to the network 4, when the image forming apparatus 1 is used as a network printer. The printer controller 1b receives a data of a printing object from the external device 3, and sends the data as the job to the main body part 1a.

The printer controller 1b comprises a controller control section 11; a DRAM control IC 12; the image memory 13; and the LANIF 14.

The controller control section 11 integrally controls each unit of the printer controller 1b, and sends a data input from the external device 3 as a job to the main body part la through the LANIF 14.

The DRAM control IC 12 controls the storing of a data received by the LANIF 14 in the image memory 13, and the retrieving of the data from the image memory 13. Further, The DRAM control IC 12 is connected to the DRAM control IC 160 of the image control substrate 100 through a Peripheral Components Interconnect (PCI) bus, and retrieves the data of the printing object from the image memory 13 to output the data to the DRAM control IC 160, according to an instruction from the controller control section 11.

The image memory 13 comprises a DRAM, and temporarily stores an output data which has been input.

The LANIF 14 is a communication interface to be connected to the network 4, such as a LAN and the like such as a Network Interface Card (NIC) and a modem and the like, and receives a data from the external device 3. The received data is output to the DRAM control IC 12.

Next, an operation of the present embodiment 1 is described.

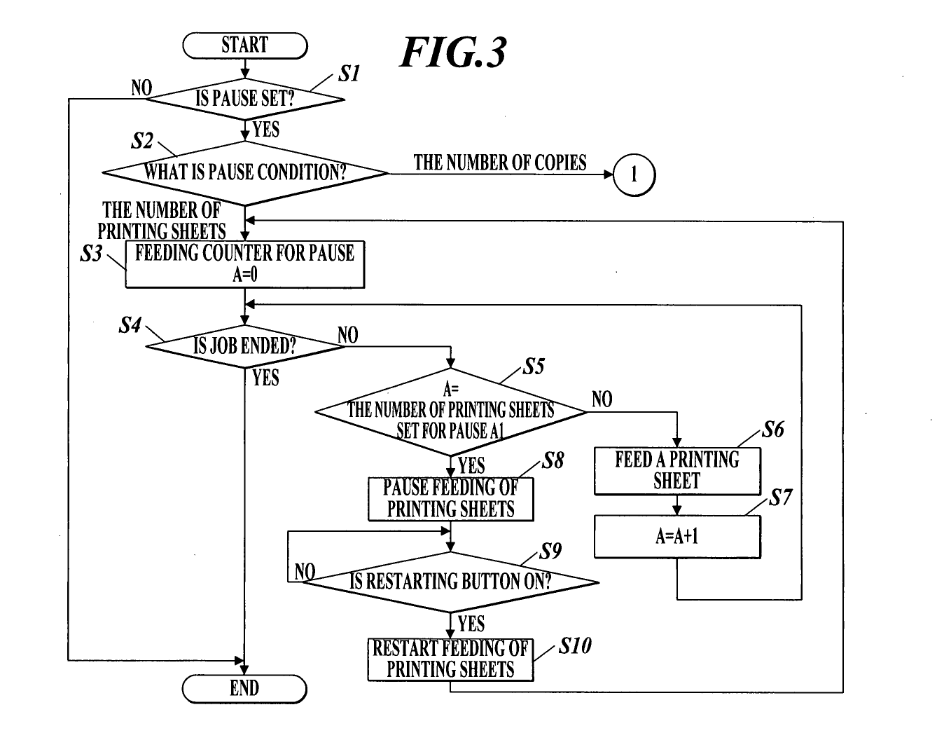

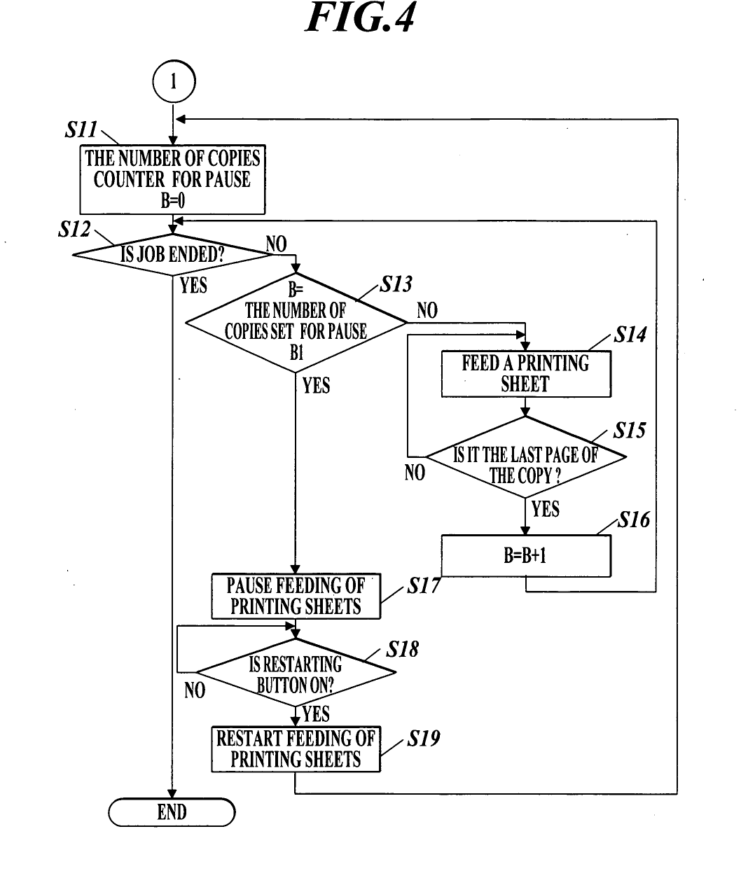

FIGS. 3-5 show flow charts of the feeding-pause processing in the present embodiment 1. The flow charts shown in FIGS. 3-5 are a processing executed by the control unit 110.

The control unit 110 determines whether an instruction to execute the feeding-pause processing is received by the operation displaying section 30 (pause is set) or not, before executing the job (step S1). When the instruction to execute the feeding-pause processing is not received (step S1; No), the control unit 110 ends the present processing, and executes the usual feeding processing performed at the time of executing a job (for example, a processing in which the printing sheets are fed until the ejection tray T3 reaches its loading limit).

When the instruction to execute the feeding-pause processing is received (step S1; Yes), the control unit 110 determines that the pause condition set by the operation displaying section 30 is either the number of printing sheets to be fed by the feeding unit 41, or the number of copies to be ejected to the ejection tray (step S2).

When the number of printing sheets is set as the pause condition (step S2; the number of printing sheets), the control unit 110 sets a feeding counter A used for the feeding-pause processing to 0 (step S3), and determines whether the job is ended or not (step S4).

When the job is ended (step S4; Yes), the control unit 110 ends the present processing. When the job is not ended (step S4; No), the control unit 110 determines whether the feeding counter A is equal to the number of the printing sheets set as the pause condition (the number of printing sheets set for pause A1) or not (step S5).

When the feeding counter A is not equal to the number of printing sheets set for pause A1 (step S5; No), the control unit 110 instructs the feeding unit 41 to feed one printing sheet (step S6), adds one to the feeding counter A (step S7), and returns to step S4.

When the feeding counter A is equal to the number of printing sheets set for pause A1 (step S5; Yes), the control unit 110 instructs the feeding unit 41 to pause the feeding of the printing sheets (step S8), determines whether the restarting button 32 is pressed down as the restarting condition or not (step S9), and when the restarting button 32 is not pressed down (step S9; No), returns to step S9.

When the restarting button 32 is pressed down (step S9; Yes), the control unit 110 instructs the feeding unit 41 to restart the feeding of the printing sheets which has been paused in step S8, to feed one printing sheet (step S10), and returns to step S3.

When the number of copies ejected to the ejection tray is set as the pause condition (step S2; the number of copies), the control unit 110 sets the number of copies counter B used for the feeding-pause processing to 0 (step S11), and determines whether the job is ended or not (step S12).

When the job is ended (step S12; Yes), the control unit 110 ends the present processing. When the job is not ended (step S12; No), the control unit 110 determines whether the number of copies counter B is equal to the number of copies set for pause (the number of copies set for pause B1) or not (step S13).

When the number of copies counter B is not equal to the number of copies set for pause B1 (step S13; No), the control unit 110 instructs the feeding unit 41 to feed one printing sheet (step S14), determines whether the fed printing sheet is the last page of the copy or not (step S15), and when the printing sheet is not the last page (step S15; No), returns to step S14.

When the fed printing sheet is the last page (step S15; Yes), the control unit 110 adds one to the number of copies counter B (step S16), and returns to step S12.

When the number of copies counter B is equal to the number of copies set for pause B1 (step S13; Yes), the control unit 110 instructs the feeding unit 41 to pause the feeding of the printing sheets (step S17), determines whether the restarting button 32 is pressed down as the restarting condition or not (step S18), and when the restarting button 32 is not pressed down (step S18; No), returns to step S18.

When the restarting button 32 is pressed down (step S18; Yes), the control unit 110 instructs the feeding unit 41 to restart the feeding of the printing sheets which has been paused in step S17 (step S19), and returns to step S11.

In this manner, the feeding which has been paused can be restarted based on the instruction to restart the feeding, which is given when the restarting button 32 is pushed down by a user. Thus, the feeding can be restarted at the timing when the user desires to do so, so that the convenience is improved.

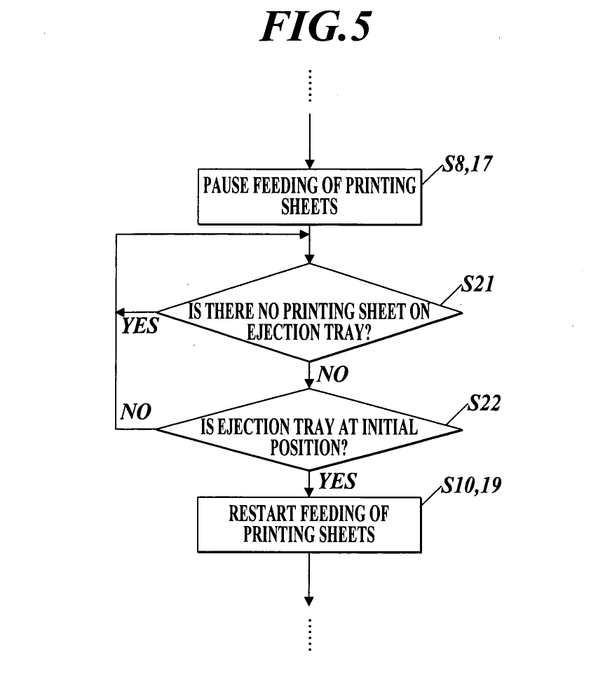

Incidentally, instead of steps S9 and S18 where the restarting condition is whether the restarting button 32 is pressed down or not, the state of the ejection tray T3 may also be the restarting condition. With reference to FIG. 5, a flow chart of a substitution example of steps S9 and S18 when the state of the ejection tray T3 is set as the restarting condition will be shown.

After the control unit 110 instructs the feeding unit 41 to pause the feeding of the printing sheets (after step S8 or S17), as the restarting condition, the control unit 110 first determines whether there is no printing sheet on the ejection tray T3 or not based on a detection signal from the printing sheet sensor 51a (step S21), and when there is a printing sheet on the ejection tray T3 (step S21; Yes), returns to step S21.

When there is no printing sheet on the ejection tray T3 (step S21; No), as the-restarting condition, the control unit 110 determines whether the ejection tray T3 is at the initial position or not based on a detection signal from the position sensor 51b (step S22), and when the ejection tray T3 is not at the initial position (step S22; No), returns to step S21.

When the ejection tray T3 is at the initial position (step S22; Yes), the control unit 110 instructs the feeding unit 41 to restart the feeding of the printing sheets which has been paused in step S8 or S17 (step S10 or S19), and returns to step S3 or S11.

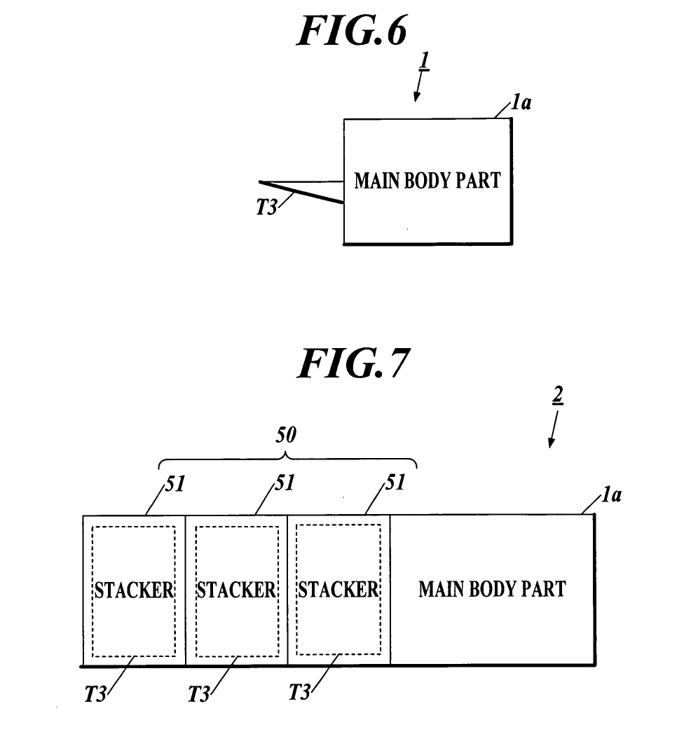

Incidentally, the image forming apparatus 1 in the present embodiment 1 is described as the image forming apparatus comprising the main body part 1a; and the post-processing part 50 comprising the ejection tray T3 and the post-processing units. However, as shown in FIG. 6, the image forming apparatus may be provided with the ejection tray T3 at the discharging unit 44 of the main body part 1a.

In this manner, the feeding which has been paused can be restarted based on the state of the ejection tray to which the fed printing sheets are ejected, that is, based on whether there is a printing sheet loaded on the ejection tray, or the position of the printing sheet. Thus, an appropriate ejecting destination of the printing sheets, that is, the ejection tray to which the printing sheets can be ejected can be assured, and the-printing sheets can be ejected to the ejection tray.

As described above, according to the present embodiment 1, the feeding can be paused based on the pause condition desired by a user. Thus, the trouble of the sorting task of the ejected printing sheets can be reduced, so that the convenience is improved.

Especially, the feeding can be paused based on the number of printing sheets or the number of copies of printing sheets as the pause condition, and segmenting a stack of printing sheets which is supposed to be continuous can be prevented. Thus, the efficiency of the sorting task of the ejected printing sheets can be increased. Further, the feeding which has been paused can be restarted based on the restarting condition, and the effective efficiency of a job can be increased, thus the convenience can be improved.

### Embodiment 2

Hereinbelow, an embodiment 2 of the present invention will be described in detail with reference to the drawings.

FIG. 7 is a schematic configuration diagram of an image forming apparatus 2 in the present embodiment 2.

As shown in FIG. 7, the image forming apparatus 2 in the present embodiment 2 comprises the main body part 1a described in the embodiment 1; and the post-processing part 50 comprising a plurality of stackers to accommodate the printing sheets on which an image is formed to the ejection tray T3. Accordingly, the illustration and description of each unit inside the image forming apparatus 2, which are similar to the embodiment 1, are omitted.

The configuration of the control block diagram of the image forming apparatus 2 of the present embodiment 2 is almost the same as the configuration of the control block diagram of the image forming apparatus of the embodiment 1 shown in FIG. 2. Thus, the drawing is omitted, and only the different items will be described.

The control unit 110 of the present embodiment 2 controls the following processing. That is, the control unit 110 retrieves the feeding-pause processing program at the time of executing the job according to the present embodiment 2, the instruction of whether to execute the feeding-pause processing or not, and various data such as the pause condition and the like from the nonvolatile memory 120, to switch the ejection tray to which the printing sheets are ejected, and to make the feeding by the feeding unit 41 to pause, in cooperation with the program and various data, based on the pause condition and the state of the ejection tray T3 of each stacker 51 detected by the printing sheet sensor 51a and the position sensor 51b. After the feeding by the feeding unit 41 is made to pause based on the pause condition, the control unit 110 controls the processing of restarting the feeding by the feeding unit based on the restarting condition which is set in advance.

The nonvolatile memory 120 of the present embodiment 2 stores various processing programs and data regarding the image forming, the feeding-pause processing of the present embodiment 2, the instruction data of whether to execute the feeding-pause processing or not, the pause condition, the restarting condition, and data processed by various programs and the like.

Next, an operation of the present embodiment 2 is described.

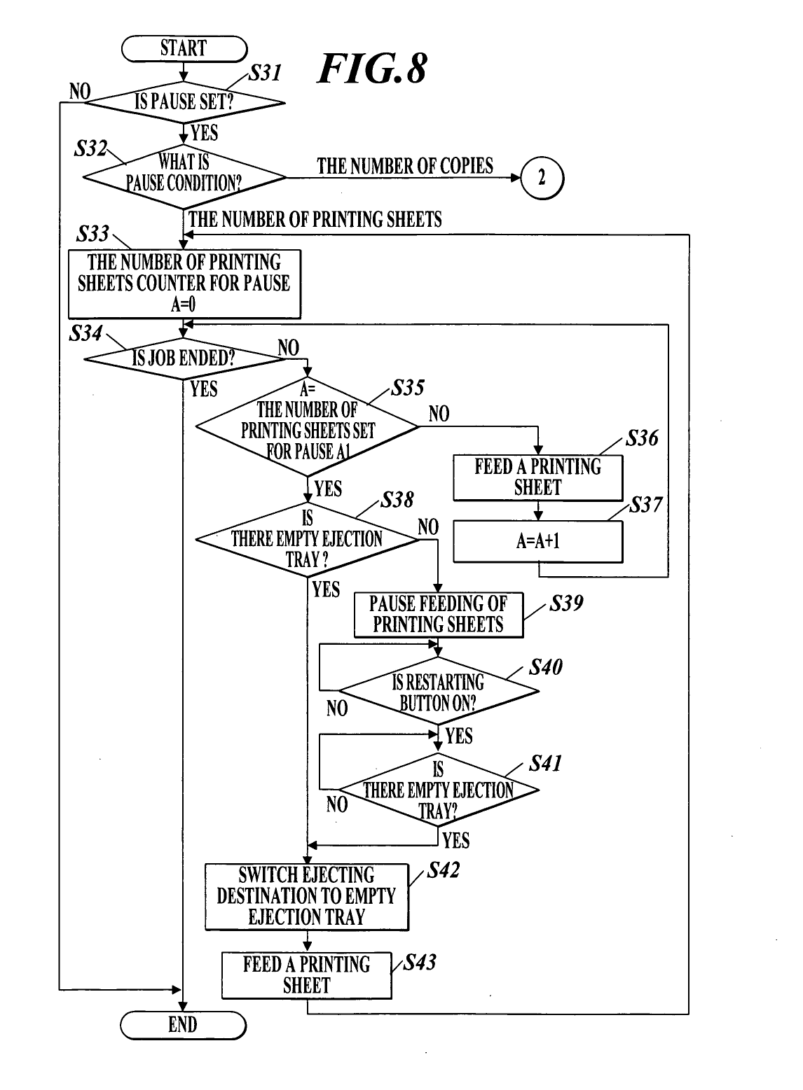

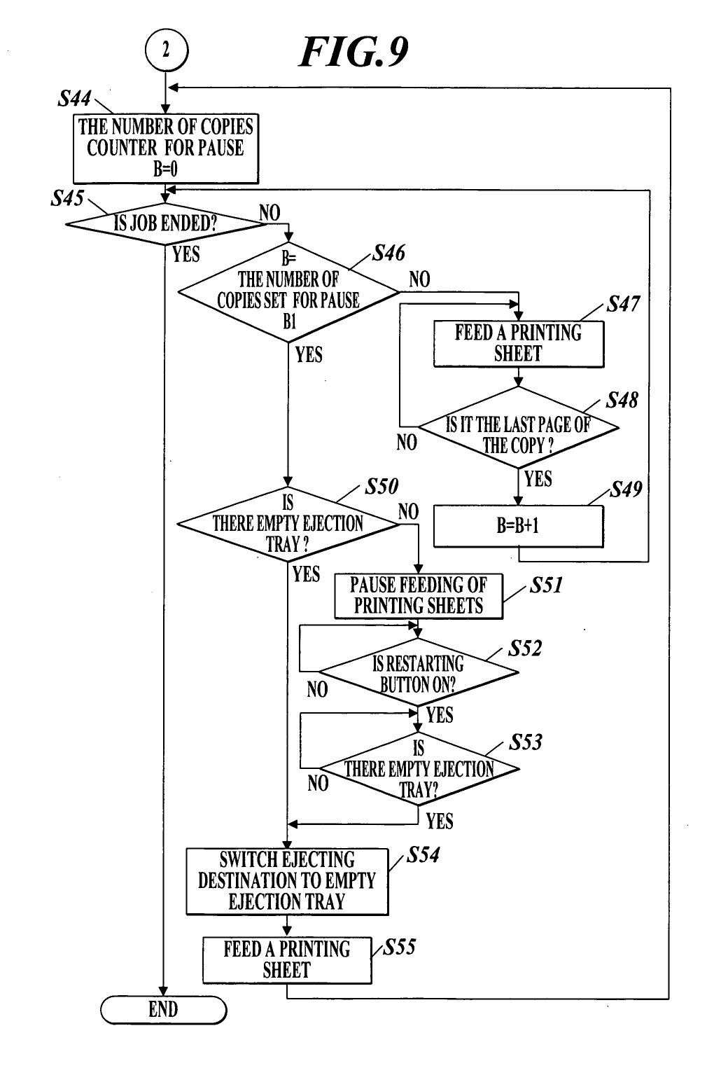

FIGS. 8 and 9 are flow charts of the feeding-pause processing in the present embodiment 2. The flow charts shown in FIGS. 8 and 9 are processing executed by the control unit 110.

Steps S31-S37 are the same as steps S1-S7 in the embodiment 1, thus the description thereof is omitted.

When the feeding counter A is equal to the number of printing sheets set for pause A1 (step S35; Yes), the control unit 110 determines whether there is an empty ejection tray at the initial position, on which there is no printing sheet or not, based on the detection signal from the printing sheet sensor 51a and the position sensor 51b provided at the ejection tray T3 of each stacker (step S38).

When there is no empty ejection tray (step S38; No), the control unit 110 instructs the feeding unit 41 to pause the feeding of the printing sheets (step S39), determines whether the restarting button 32 is pressed down as the restarting condition or not (step S40), and when the restarting button 32 is not pressed down (step S40; No), returns to step S40.

When the restarting button 32 is pressed down (step S40; Yes), the control unit 110 determines whether there is an empty ejection tray at the initial position, on which there is no printing sheet or not, based on the detection signal from the printing sheet sensor 51a and the position sensor 51b provided at the ejection tray T3 of each stacker (step S41).

When there is no empty ejection tray (step S41; No), the control unit 110 returns to step S41. When there is an empty ejection tray (step S41; Yes) or after step S38; Yes, the control unit 110 switches the ejecting destination of the printing sheets to any one of the ejection trays determined to be the empty ejection trays (step S42). The control unit 110 instructs the feeding unit 41 to feed one printing sheet to be ejected to the ejection tray which has been switched to as the ejecting destination (step S43), and returns to step S34. Accordingly, the printing sheet fed in step S43 is ejected to an empty ejection tray.

When the number of copies ejected to the ejection tray is set as the pause condition (step S32; the number of copies), the control unit 110 proceeds to step S44. Steps S44-S49 are the same as steps S11-S16 in the embodiment 1, thus the description thereof is omitted.

When the number of copies counter B is equal to the number of copies set for pause B1 (step S46; Yes), the control unit 110 determines whether there is an empty ejection tray at the initial position, on which there is no printing sheet or not, based on the detection signal from the printing sheet sensor 51a and the position sensor 51b provided at the ejection tray T3 of each stacker (step S50).

When there is no empty ejection tray (step S50; No), the control unit 110 instructs the feeding unit 41 to pause the feeding of the printing sheets (step S51), determines whether the restarting button 32 is pressed down as the restarting condition or not (step S52), and when the restarting button 32 is not pressed down (step S52; No), returns to step S52.

When the restarting button 32 is pressed down (step S52; Yes), the control unit 110 determines whether there is an empty ejection tray at the initial position, on which there is no printing sheet or not, based on the detection signal from the printing sheet sensor 51a and the position sensor 51b provided at the ejection tray T3 of each stacker (step S53).

When there is no empty ejection tray (step S53; No), the control unit 110 returns to step S53. When there is an empty ejection tray (step S53; Yes) or after step S50; Yes, the control unit 110 switches the ejecting destination of the printing sheets to any one of the ejection trays determined to be the empty ejection trays (step S54). The control unit 110 instructs the feeding unit 41 to feed one printing sheet to be ejected to the ejection tray which has been switched to as the ejecting destination (step S55), and returns to step S45. Accordingly, the printing sheet fed in step S55 is ejected to an empty ejection tray.

Incidentally, in the same manner as in the embodiment 1, instead of steps S40 and S52 where the restarting condition is whether the restarting button 32 is pressed down or not, the state of the ejection tray T3 may also be the restarting condition, as shown in steps S21 and S22 in FIG. 5.

As described above, according to the present embodiment 2, the feeding can be paused based on the pause condition desired by a user. Thus, the trouble of the sorting task of the ejected printing sheets can be reduced, so that the convenience is improved.

Especially, the feeding can be paused based on the number of printing sheets or the number of copies of printing sheets as the pause condition, and segmenting a stack of printing sheets which is supposed to be continuous can be prevented. Thus, the efficiency of the sorting task of the ejected printing sheets can be increased. Further, the feeding which has been paused can be restarted based on the restarting condition (the restarting button 32 being pushed down or the state of the ejection tray), and the effective efficiency of a job can be increased, thus the convenience can be improved. Moreover, the ejection tray to which the printing sheets are ejected can be switched based on the pause condition and the state of each ejection tray. Thus, the ejection tray can be automatically switched to one capable of ejecting the printing sheets without an interposition of a user, and a continuous processing of image forming and ejecting printing sheets can be continued. Therefore, the working property and the convenience can be improved.

Further, the present invention is not limited to the above described contents of the embodiments 1 and 2, but can be modified within the scope not departing from the principle of the present invention.

According to a first aspect of the preferred embodiments of the present invention, there is provided an image forming apparatus comprising:

a feeding section to perform a feeding of printing sheets;

an image forming section to perform an image forming for the printing sheets fed by the feeding section;

an ejection tray to which the printing sheets for which the image forming is performed by the image forming section are ejected;

an input section to receive a pause condition of the feeding performed by the feeding section; and

a control section to instruct the feeding section to pause the feeding based on the pause condition received by the input section.

According to one aspect of the present invention, the feeding can be paused based on the pause condition desired by a user. Thus, the trouble of the sorting task of the ejected printing sheets can be reduced, so that the convenience is improved.

Preferably, the pause condition is the number of the printing sheets fed by the feeding section, or the number of the printing sheets ejected to the ejection tray.

Further, when the number of printing sheets fed by the feeding unit or the number of copies of printing sheets ejected to the ejection tray is set as the pause condition, segmenting a stack of printing sheets which is supposed to be continuous can be prevented. Thus, the efficiency of the sorting task of the ejected printing sheets can be increased.

Preferably, after the control section instructs the feeding section to pause the feeding based on the pause condition received by the input section, the control section instructs the feeding section to restart the feeding based on a restarting condition which is predetermined.

Further, when the feeding which has been paused is restarted based on the restarting condition set in advance, the effective efficiency of a job can be increased, thus the convenience can be improved.

Preferably, the input section receives an instruction to restart the feeding to be performed by the feeding section, and

the control section instructs the feeding section to restart the feeding by using the instruction to restart the feeding, which is received from the input section, as the restarting condition.

Further, when the feeding is restarted based on the instruction to restart the feeding as the restarting condition, received from an input section, the feeding can be restarted at the timing when the user desires to do so, so that the convenience is improved.

Preferably, the image forming apparatus comprises a detecting section to detect a state of the ejection tray, wherein

the control section instructs the feeding section to restart the feeding by using the state of the ejection tray, which is detected by the detecting section, as the restarting condition.

Further, when the feeding which has been paused is restarted based on the state of the ejection tray detected by the detecting section as the restarting condition, the ejection tray as the appropriate ejecting destination of the printing sheets can be assured.

Preferably, the state of-the ejection tray is whether there is a printing sheet loaded on the ejection tray or not, or a position of the ejection tray.

Further, when the feeding which has been paused is restarted based on whether there is a printing sheet loaded on the ejection tray or the position of the ejection tray as the restarting condition, the printing sheets can be ejected to the ejection tray to which the printing sheets can be ejected.

Preferably, the image forming apparatus comprises a plurality of ejection trays, wherein

the control section switches the ejection tray to which the printing sheets are ejected, based on the pause condition and the state of each of the ejection trays, which is detected by the detecting section.

Further, when the ejection tray to which the printing sheets are ejected is switched based on the pause condition and the state of each ejection tray, the ejection tray can be automatically switched to one to which the printing sheets can be ejected without an interposition of a user, and a continuous processing of feeding printing sheets, image forming and ejecting the printing sheets can be continued. Thus the working property and the convenience can be improved.

The present U.S. patent application claims a priority under the Paris Convention of Japanese patent application No. 2007-236686 filed on Sep. 12, 2007, which shall be a basis of correction of an incorrect translation.

What is claimed is:

1. An image forming apparatus comprising:
a feeding section to perform a feeding of printing sheets;
an image forming section to perform an image forming for the printing sheets fed by the feeding section;
an ejection tray to which the printing sheets for which the image forming is performed by the image forming section are ejected;
an input section to receive a pause condition of the feeding performed by the feeding section; and
a control section to instruct the feeding section to pause the feeding based on the pause condition received by the input section.

2. The image forming apparatus of claim 1, wherein
the pause condition is the number of the printing sheets fed by the feeding section, or the number of the printing sheets ejected to the ejection tray.

3. The image forming apparatus of claim 1, wherein
after the control section instructs the feeding section to pause the feeding based on the pause condition received by the input section, the control section instructs the feeding section to restart the feeding based on a restarting condition which is predetermined.

4. The image forming apparatus of claim 3, wherein
the input section receives an instruction to restart the feeding to be performed by the feeding section, and
the control section instructs the feeding section to restart the feeding by using the instruction to restart the feeding, which is received from the input section, as the restarting condition.

5. The image forming apparatus of claim 3, comprising a detecting section to detect a state of the ejection tray, wherein
the control section instructs the feeding section to restart the feeding by using the state of the ejection tray, which is detected by the detecting section, as the restarting condition.

6. The image forming apparatus of claim 5, wherein the state of the ejection tray is whether there is a printing sheet loaded on the ejection tray or not, or a position of the ejection tray.

7. The image forming apparatus of claim 5, comprising a plurality of ejection trays, wherein
the control section switches the ejection tray to which the printing sheets are ejected, based on the pause condition and the state of each of the ejection trays, which is detected by the detecting section.
